(19) United States
(12) Patent Application Publication
(10) Pub. No.: US 2011/0167001 A1
(43) Pub. Date: Jul. 7, 2011

(54) GEODICTIONARY

(75) Inventors: David Stephens, Arvada, CO (US); Kristen Davis, Littleton, CO (US); James Ludwig, Stevens, PA (US); Joseph Ninan, Saddle Brook, NJ (US); Jeannette Russell, Somerset, NJ (US); Alexander Varakin, Parsippany, NJ (US)

(73) Assignee: The Western Union Company, Englewood, CO (US)

(21) Appl. No.: 12/683,771

(22) Filed: Jan. 7, 2010

(51) Int. Cl. G06Q 40/00; G06F 17/30

(52) U.S. Cl. 705/44; 707/769; 707/E17.014; 707/E17.018

(57) ABSTRACT

Methods, systems, and devices are described for determining compliance with a listing of persons banned from conducting financial transactions. Words appearing in a listing of a banned person and a financial transaction may be compared with defined words appearing in a database. Common words appearing in both the listing of the banned person and the database, and the transaction record and the database, may be identified, thereby identifying a first and second set of common defined words. The listing of the banned person is linked with countries based on the first set of common defined words and/or phrases and the transaction record is linked with countries based on the second set of common defined words and/or phrases. The countries may then be compared. Based on the outcome, the financial transaction may be permitted or suspended.

### BACKGROUND OF THE INVENTION

Throughout the world, large volumes of financial transactions are conducted on a daily basis. These financial transactions occur between parties residing in the same country and different countries. Complicating matters, many countries create lists of persons prohibited from conducting financial transactions within their borders. These persons may be criminals, money launderers, and/or terrorists, to name only a few examples. In order to conduct business in these countries, entities providing financial transaction services must block and/or report transactions involving persons appearing on these lists.

However, due to the thousands of financial transaction conducted on a daily basis, a financial transaction may be conducted by a law-abiding persons who happens to have the same name as someone appearing on a country's list of banned persons. While the person conducting the financial transaction may have the same name, in many instances this is simply an unfortunate coincidence.

Such a coincidence may trigger an investigation. If such a coincidence occurs, it may involve the financial transaction being suspended while a trained professional looks at details of the financial transaction and the person appearing on the list of banned persons. The trained professional may then release the transaction after determining that the similarity in name between the banned person and the person conducting the financial transaction is only a coincidence. Such false-positives may result in the financial transaction being suspended for a significant amount of time. Such false-positives may also be expensive to the entity hosting the financial transaction, as it may have to train and employ specialized personnel to screen these matches prior to either releasing the financial transaction or forwarding information regarding the financial transaction to another entity, such as a government agency, for further investigation and/or action against the party conducting the financial transaction.

The invention that follows addresses these and other problems.

### BRIEF SUMMARY OF THE INVENTION

Techniques are described for determining compliance with a listing of persons banned from conducting financial transactions. Words appearing in a listing of a banned person and a financial transaction may be compared with defined words appearing in a database. Common words appearing in the listing of the banned person and the database may be identified. The listing of the banned person is then linked with certain countries based on the common words and/or phrases. Also, common words/phrases appearing in the financial transaction record and the database may be identified. The financial transaction record may be linked with certain countries based on the common words/phrases. The two sets of countries may then be compared. Based on the outcome, the financial transaction may be permitted, suspended, or further reviewed.

In some embodiments, a method for determining compliance with a listing of persons banned from conducting financial transactions is described. The method includes providing a host system comprised of a processor and a computer-readable storage device. The method also includes receiving the listing of persons, wherein the listing of persons identifies a first person and a location. The method further includes receiving a plurality of words and/or phrases and a plurality of locations wherein each location of the plurality of locations is linked to at least one word and/or phrase of the plurality of words and/or phrases, thereby creating a geographic-word database. The method also includes receiving financial transaction information, wherein the financial transaction information comprises information about a sender and/or recipient of a financial transaction. The method includes comparing words and/or phrases present in the financial transaction information with the plurality of words and/or phrases in the geographic-word database. The method includes identifying a word and/or phrase in the financial transaction information in common with a first word and/or phrase in the geographic-word database. The method also includes, linking a first location in the geographic-word database previously linked with the first word and/or phrase to the financial transaction information. Finally, the method includes comparing the first location and the second location.

In some embodiments, a name of the sender contained in the financial transaction information is compared to a name appearing on the listing of persons banned from conducting financial transactions and the name of the sender contained in the financial transaction information is determined to match a person appearing on lists of banned persons.

In some embodiments, the method includes comparing words and/or phrases present in the listing of persons banned from conducting financial transactions with the plurality of words and/or phrases present in the geographic-word database. The method may also include identifying a word and/or phrase in the listing of a person from among the banned persons appearing on the list of banned persons in common with the second word or phrase in the geographic database. The method may include linking a first location in the geographic database to the second common word and/or phrase the listing of the banned persons appearing on the list of banned persons.

In some embodiments, a system for determining compliance with a list of persons prohibited from conducting financial transactions is described. The system may include a user display, wherein the user display is configured to display financial transaction information to a user. The system may also include an input device, wherein the input device is configured to receive input from the user to change the status of the financial transaction. The system may also include a computer-readable storage medium. Also, a database may be included. The database may reside on the computer-readable storage medium and may comprise a plurality of defined words and/or phrases linked to one or more names of countries. The system may also include a host computer system. The host computer system may comprise a processor and the computer-readable storage medium. The computer-readable storage medium may have encoded thereon a set of instructions to control operation of the host computer system. The set of instructions may include instructions for receiving a listing of banned persons wherein the listing of banned persons may comprise names of banned persons and additional information for at least a subset of the banned persons. The instructions may also include identifying common words and/or phrases appearing in both the listing of the banned person and the defined words and/or phrases in the database, thereby identifying a first set of common defined words and/or phrases. The instructions may also include instructions for linking the listing of the banned person to the one or more names of countries linked with the first set of common defined words and/or phrases.

The instruction set may further include instructions for receiving a financial transaction record, wherein the financial transaction record comprises a person's name and information about a sender and/or recipient of a financial transaction. Also, it may include instructions for comparing the person's name appearing in the financial transaction record with names of persons appearing in the listing of banned persons. The instruction set may include instructions for identifying the person's name appearing in the financial transaction record as also appearing in the listing of banned persons. The instruction set may further include instructions for comparing words and/or phrases appearing in the financial transaction record with the plurality of defined words and/or phrases appearing in the database. The instruction set may further include instructions for identifying common words and/or phrases appearing in both the financial transaction record and the database, thereby identifying a second set of common defined words and/or phrases. The instruction set may further include instructions for linking the financial transaction record to one or more names of countries linked with the second set of common defined words and/or phrases in the database.

In some embodiments, a computer-readable storage medium having a computer-readable program embodied therein for directing the operation of a computer system is described. The computer system may include a processor in a storage device, wherein the computer-readable program includes instructions for operating the computer system to determine compliance with a list of persons prohibited from conducting financial transactions. The method may include receiving a money transfer transaction record, wherein the money transfer transaction record comprises information regarding a sender of a money transfer. The method may also include comparing a name of the sender to a list of names of persons prohibited from conducting financial transactions. The method may also include determining a name of the sender matches a name on the list of names of persons prohibited from conducting financial transactions. The money transfer transaction may be placed in a suspended status. The money transfer transaction record may be searched for a set of keywords and/or key phrases. At least one keyword and/or key phrase within the money transfer transaction record may be located. The money transfer transaction record may be linked with a country name linked with the at least one keyword and/or key phrase in the database. The method may also includes searching the countries linked with the name on lists of names of persons prohibited from conducting financial transactions for countries linked to the money transfer transaction record. No country linked with the name on the list of names of persons prohibited from conducting financial transactions may be determined to match the country name links to the money transfer transaction record. Finally the money transfer transaction may be released from the suspended status.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates a simplified block diagram of an embodiment of a system for determining compliance with a list of persons banned from financial transactions.

FIG. 2a illustrates a simplified block diagram of an embodiment of a host computer system for determining compliance with a list of persons banned from financial transactions.

FIG. 2b illustrates a simplified block diagram of an embodiment of a network of computer devices that may function as a host computer system.

FIG. 3 illustrates a simplified embodiment of a list of persons banned from financial transactions.

FIG. 4 illustrates a simplified embodiment of a table from a GeoDictionary database.

FIG. 5 illustrates a simplified method of linking words and/or phrases in a list of persons banned from financial transactions with associated countries.

FIG. 6 illustrates a simplified method of determining whether a person involved in a financial transaction warrants further investigation as to whether she is a person banned from financial transactions.

### DETAILED DESCRIPTION OF THE INVENTION

A set of embodiments provides solutions (including without limitation, devices, systems, methods, software programs, and the like) for determining whether a person involved in a financial transaction is likely to be the same person as a person listed in a list of persons banned from financial transactions. In particular, some embodiments compare the names of persons appearing in a financial transaction record to names appearing on a list of banned persons. If no name is found in common, the financial transaction is permitted. If a name does match, the country or countries involved in the financial transaction may be compared with a country or countries related to the person appearing on the list of banned persons. Such a comparison of countries may involve the use of a database that links words and/or phrases appearing in a financial transaction record and/or the list of banned persons to particular countries. The database, referred to as a geographic-word dictionary or a “GeoDictionary,” may include data such as names of organizations, keywords, names of persons, places, etc. that are linked to a particular location. For example, Al-Qaeda may be linked to Afghanistan. Therefore, if a name of a person on a list of banned persons was listed as a member of Al-Qaeda, that person would be linked to the country of Afghanistan. A GeoDictionary may be used to link various words and/or phrases to particular locations or countries in both transaction records and lists of banned persons.

Following the linking of various words and/or phrases in the financial transaction record and/or lists of banned persons with countries, the countries linked with a financial transaction record may be compared to the countries linked with the person sharing the same name on the list of banned persons. If there is a match of a country name, this may result in the financial transaction record being forwarded to a user and/or government agency for further analysis. If no country is found in common between the financial transaction record and the person sharing the same name on the list of banned persons, the financial transaction may be released and allowed to be completed without requiring the intervention of a user and/or government agency.

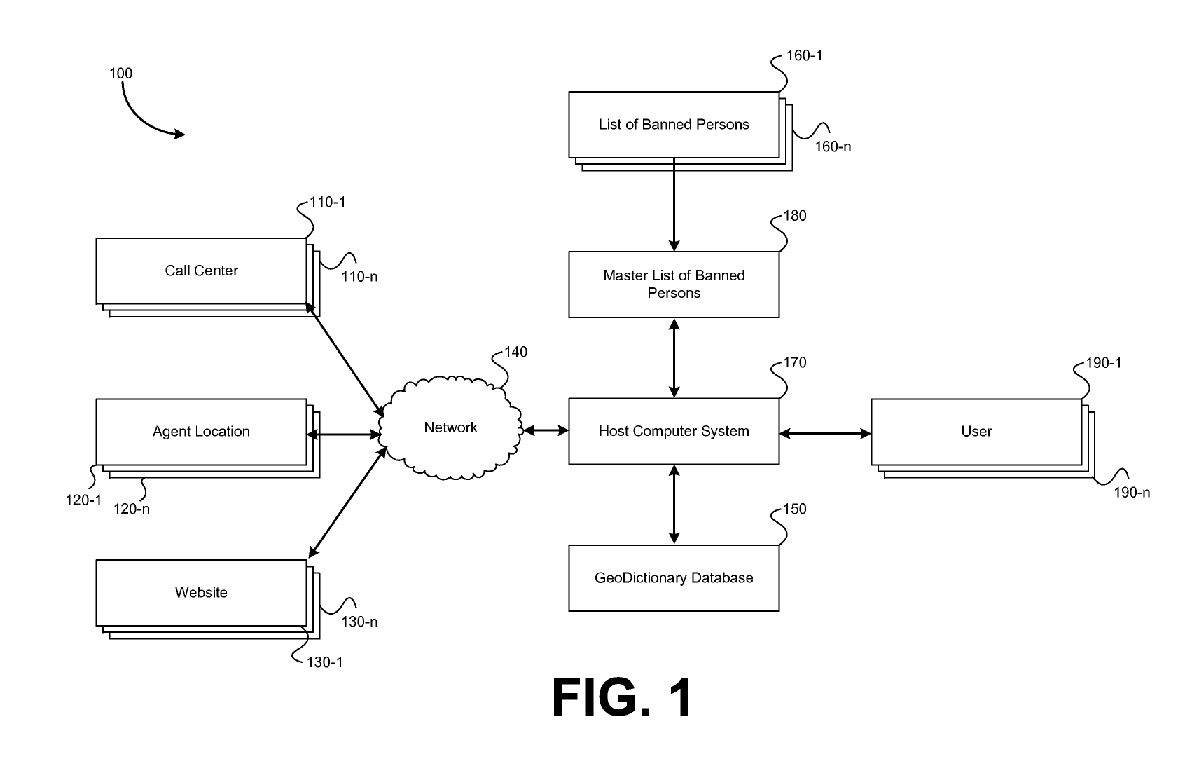

FIG. 1 illustrates a simplified block diagram of an embodiment of a system 100 for determining compliance with a list of persons banned from financial transactions. System 100 may include: call centers 110-1 through 110-n, agent locations 120-1 through 120-n, websites 130-1 through 130-n, a network 140, lists of banned persons 160-1 through 160-n, a master list of banned persons list 180, a host computer system 170, and a GeoDictionary database 150.

List of banned persons 160-1 may be a list produced by an agency of a country's government. This source list may include a listing of one or more names of persons not permitted to conduct financial transactions within the country in question. Beyond providing the name of the person, the list of banned persons 160-1 may include information regarding the person's last known address, the person's memberships in organizations, country names of places the person may reside, the person's date of birth, the person's political affiliation, etc. Further, a country may produce one or more than one list of persons banned from financial transactions. For example, different agencies within one country's government may each produce a list of banned persons, both of which require compliance by the entity hosting the financial transaction. Also, many countries (or organizations, such as the United Nations) may produce such lists. Each of these lists 160-n may also need to be used to block certain persons' financial transactions. Therefore, the entity hosting the financial transactions may be required to either comply with each list of banned persons within the country producing the list, or may be required to comply with a country's list of banned persons worldwide. Therefore, in some instances, an entity hosting financial transactions may compile the various lists produced by various governments and agencies within governments to create a master list of banned persons. This master list of banned persons may then be employed worldwide for compliance with all lists provided by different countries.

The lists of banned persons 160-1 through 160-n may be compiled by the entity hosting financial transactions. This may involve using some or all of the information included in the lists of banned persons 160-1 through 160-n being added to a master list of banned persons 180. This information may include biographical information such as the banned person's name, date of birth, place of birth, identification issuing country, country of residence, family relations, etc. The entity hosting financial transactions may introduce additional information to the master list of banned persons 180. For example, additional information from a GeoDictionary, such as GeoDictionary 150, may be added to the master list of banned persons 180. Further, it is possible that the same person may appear on multiple countries' lists of banned persons. If so, each country's entry for the person on its respective lists of banned persons may be combined into one entry on the master list of banned persons 180.

The entity hosting the financial transaction, such as WESTERN UNION, may create and/or have access to a GeoDictionary database 150. A GeoDictionary 150 may be a compilation of words and/or phrases that tend to be linked with a particular country. For example, the terrorist organization Al-Qaeda may be linked to the country Iran and/or Sudan. Besides organizations, any word and/or phrase may be added to the GeoDictionary 150 if the word and/or phrase is determined to be linked to one or more particular countries (or other locations, such as cities, regions, states, etc). The GeoDictionary 150 may link countries with other countries. Such an association may be useful if a border between the two countries is porous, allowing persons in a first country to easily move to a second country, thereby avoiding law enforcement in the first country. For example, Afghanistan may be linked with Pakistan. In another example, countries in the European Union may be linked with each other due to reduced border restrictions within the EU.

The Geodictionary 150 may be updated by a user at the financial entity hosting financial transactions, or may be created and maintained by an outside party (such as a private company or a government agency). The GeoDictionary 150 may be a database maintained remotely from the host computer system 170, or may be local to the host computer system 150. In some embodiments, the GeoDictionary 150 is a table. The GeoDictionary 150 may be stored on an electronic storage medium, such as a hard drive, flash drive, computer memory, or device capable of storing such information.

A host computer system 170 may store or interact with both the master list of banned persons 180 and the GeoDictionary database 150. The host computer system 170 may be a single computer or may be a network of distributed computers. The host computer system 170 may be able to access the GeoDictionary database whether the GeoDictionary database 150 is stored local to the host computer system 170 or stored remotely. The GeoDictionary database 150 may be accessible via a network, such as the Internet or a private intranet. Similarly, the host computer system 170 may be able to access the master list of banned persons 180 whether the master list of banned persons 180 is stored local to the host computer system 170 or stored remotely. The master list of banned persons 180 may also be accessible via a network, such as the Internet or a private intranet. The host computer system 170 may also receive and store the lists of banned persons received from various countries and/or agencies of governments of countries 160-1 through 160-n.

The host computer system 170 may interact with network 140, such as a private intranet, or a public network such as the Internet, to communicate with various handlers that may receive and payout financial transactions, including money transfer transactions. A first handler may be a call center 110-1. Call center 110-1 may receive requests for financial transactions via telephone calls from customers. For example, a customer may phone call center 110-1 and request a money transfer. An automated system or a customer representative may collect information about the customer, and/or the recipient. The amount of information gathered may be dependent on factors such as the country the transaction is originating in, the country the recipient is located in, and/or the amount of the transaction. There may be more than one call center, as illustrated by 110-n. These call centers 110-1 through 110-n may be scattered throughout a country or throughout the world. Also, these call centers 110-1 through 110-and may communicate with the host computer system 170 through a network 140.

Another handler may be agent location 120-1. Agent location 120-1 may be a physical location, such as a store or a bank, that allows a customer to create a financial transaction request. This may include a customer conducting a transaction with an agent, such as a store clerk, or through an electronic system, such as a kiosk. Whether a kiosk or an agent, certain information may be required to be collected regarding the customer and/or the recipient of the financial transaction. What information is collected may be dependent on such factors as the country the transaction is originating in, the country the recipient is located in, and/or the amount of the financial transaction. There may be any number of agent locations, illustrated as 120-n. Agent locations 120-1 through 120-n may communicate with the host computer system 170 through a network 140.

A third handler may be a website 130-1. Website 130-1 may receive information for a financial transaction from a customer. Just as with call centers 110-1 through 110-n and agent locations 120-1 through 120-n, website 130-1 may be required to collect information about the customer and/or recipient. Again, this information may vary depending on factors such as the country the transaction is originating in, the location of the recipient, and/or the amount of the transaction. Also, there may be more than one website, illustrated as 130-n. Websites 130-1 through 130-n may communicate with the host computer system 170 through network 140.

Therefore, no matter whether a financial transaction is staged through one of the three handlers described, or some other handler, information sufficient to comply with the relevant countries' laws is collected. Some or all of this information is routed to host computer system 170 for the comparison of the names of the sender and/or recipient of the financial transaction with persons' names appearing on various countries' lists of banned persons 160-1 through 160-n (possibly in the form of a master list of banned persons 180).

The host computer system 170 may also accept input from a user 190-1. The user 190-1 may be able to directly interact with host computer system 170. In some embodiments, user 190-1 may interact with the host computer system 170 remotely. This may be through a computer terminal. User 190-1 may have the ability to interact with various data on host computer system 170. For example, user 190-1 may be able to add information to the master list of banned persons 184. The user 190-1 may also be able to add, delete, and/or modify words and/or phrases linked with particular countries in the GeoDictionary database 150. Further, user 190-1 may be able to view a transaction record data originating from a call center 110-1 through 110-n, agent locations 120-1 through 120-n, website 130-1 through 130-n, and/or any other handler. The user 190-1 may be an employee of the entity hosting a financial transaction or may be a third-party, such as a law enforcement officer.

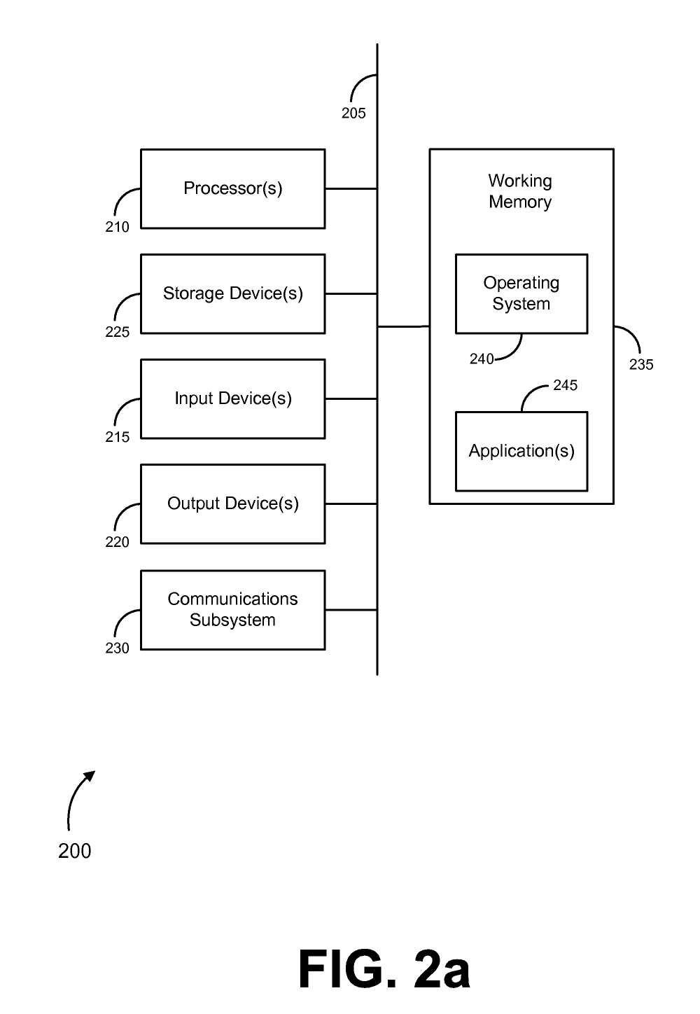

FIG. 2a provides a schematic illustration of one embodiment of a computer system 200 that can perform the methods provided by various other embodiments, as described herein, and/or can function as the host computer system 170 as illustrated in FIG. 1. It should be noted that FIG. 2A is meant only to provide a generalized illustration of various components, any or all of which may be utilized as appropriate. FIG. 2A, therefore, broadly illustrates how individual system elements may be implemented in a relatively separated or relatively more integrated manner.

The computer system 200 is shown comprising hardware elements that can be electrically coupled via a bus 205 (or may otherwise be in communication, as appropriate). The hardware elements may include one or more processors 210, including without limitation one or more general-purpose processors and/or one or more special-purpose processors (such as digital signal processing chips, graphics acceleration processors, and/or the like); one or more input devices 215, which can include without limitation a mouse, a keyboard and/or the like; and one or more output devices 220, which can include without limitation a display device, a printer and/or the like.

The computer system 200 may further include (and/or be in communication with) one or more storage devices 225, which can comprise, without limitation, local and/or network accessible storage, and/or can include, without limitation, a disk drive, a drive array, an optical storage device, solid-state storage device such as a random access memory (“RAM”) and/or a read-only memory (“ROM”), which can be programmable, flash-updateable and/or the like. Such storage devices may be configured to implement any appropriate data stores, including without limitation, various file systems, database structures, and/or the like.

The computer system 200 might also include a communications subsystem 230, which can include without limitation a modem, a network card (wireless or wired), an infra-red communication device, a wireless communication device and/or chipset (such as a BLUETOOTH device, an 802.11 device, a WiFi device, a WiMax device, cellular communication facilities, etc.), and/or the like. The communications subsystem 230 may permit data to be exchanged with a network (such as the network described below, to name one example), other computer systems, and/or any other devices described herein. In many embodiments, the computer system 200 will further comprise a working memory 235, which can include a RAM or ROM device, as described above.

The computer system 200 also can comprise software elements, shown as being currently located within the working memory 235, including an operating system 240, device drivers, executable libraries, and/or other code, such as one or more application programs 245, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or this code might be stored on a computer-readable storage medium, such as the storage device(s) 225 described above. In some cases, the storage medium might be incorporated within a computer system, such as the system 200. In other embodiments, the storage medium might be separate from a computer system (i.e., a removable medium, such as a compact disc, etc.), and/or provided in an installation package, such that the storage medium can be used to program, configure and/or adapt a general purpose computer with the instructions/code stored thereon. These instructions might take the form of executable code, which is executable by the computer system 200 and/or might take the form of source and/or installable code, which, upon compilation and/or installation on the computer system 200 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer system (such as the computer system 200) to perform methods in accordance with various embodiments of the invention. According to a set of embodiments, some or all of the procedures of such methods are performed by the computer system 200 in response to processor 210 executing one or more sequences of one or more instructions (which might be incorporated into the operating system 240 and/or other code, such as an application program 245) contained in the working memory 235. Such instructions may be read into the working memory 235 from another computer-readable medium, such as one or more of the storage device(s) 225. Merely by way of example, execution of the sequences of instructions contained in the working memory 235 might cause the processor(s) 210 to perform one or more procedures of the methods described herein.

The terms “machine-readable medium” and “computer-readable medium,” as used herein, refer to any medium that participates in providing data that causes a machine to operate in a specific fashion. In an embodiment implemented using the computer system 200, various computer-readable media might be involved in providing instructions/code to processor(s) 210 for execution and/or might be used to store and/or carry such instructions/code (e.g., as signals). Further, various computer-readable media may be used to store databases, such as GeoDictionary Database 150 of FIG. 1, or other stores of information, such as Master List of Banned Persons 180 of FIG. 1, or the Lists of Banned Persons 160-1 through 160-n. In many implementations, a computer-readable medium is a physical and/or tangible storage medium. Such a medium may take many forms, including but not limited to, non-volatile media, volatile media, and transmission media. Non-volatile media includes, for example, optical and/or magnetic disks, such as the storage device(s) 225. Volatile media includes, without limitation, dynamic memory, such as the working memory 235. Transmission media includes, without limitation, coaxial cables, copper wire and fiber optics, including the wires that comprise the bus 205, as well as the various components of the communication subsystem 230 (and/or the media by which the communications subsystem 230 provides communication with other devices). Hence, transmission media can also take the form of waves (including without limitation radio, acoustic and/or light waves, such as those generated during radio-wave and infra-red data communications).

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read instructions and/or code.

Various forms of computer-readable media may be involved in carrying one or more sequences of one or more instructions to the processor(s) 210 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 200. These signals, which might be in the form of electromagnetic signals, acoustic signals, optical signals and/or the like, are all examples of carrier waves on which instructions can be encoded, in accordance with various embodiments of the invention.

The communications subsystem 230 (and/or components thereof) generally will receive the signals, and the bus 205 then might carry the signals (and/or the data, instructions, etc. carried by the signals) to the working memory 235, from which the processor(s) 205 retrieves and executes the instructions. The instructions received by the working memory 235 may optionally be stored on a storage device 225 either before or after execution by the processor(s) 210.

Besides a single computer, such as that illustrated in FIG. 2a, serving at a host computer system, a network of computers may serve as a host computer system. Merely by way of example, FIG. 2b illustrates a schematic diagram of a system 200-b that can be used in accordance with one set of embodiments. The system 200-b can include one or more user computers 205-b. The user computers 205-b can be general purpose personal computers (including, merely by way of example, personal computers and/or laptop computers running any appropriate flavor of MICROSOFT Corp.'s WINDOWS and/or APPLE Corp.'s MACINTOSH operating systems) and/or workstation computers running any of a variety of commercially-available UNIX or UNIX-like operating systems. These user computers 205-b can also have any of a variety of applications, including one or more applications configured to perform methods provided by various embodiments (as described above, for example), as well as one or more office applications, database client and/or server applications, and/or web browser applications. Alternatively, the user computers 205-b can be any other electronic device, such as a thin-client computer, Internet-enabled mobile telephone, and/or personal digital assistant, capable of communicating via a network (e.g., the network 210-b described below) and/or displaying and navigating web pages or other types of electronic documents. Although the exemplary system 200-b is shown with three user computers 205-b, any number of user computers can be supported.

Certain embodiments of the invention operate in a networked environment, which can include a network 210-b. The network 210-b can be any type of network familiar to those skilled in the art that can support data communications using any of a variety of commercially-available (and/or free or proprietary) protocols, including without limitation TCP/IP, SNA, IPX, AppleTalk, and the like. Merely by way of example, the network 210-b can be a local area network (“LAN”), including without limitation an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network, including without limitation a network operating under any of the IEEE 802.11 suite of protocols, the BLUETOOTH protocol known in the art, and/or any other wireless protocol; and/or any combination of these and/or other networks.

Embodiments of the invention can include one or more server computers 215-b. Each of the server computers 215-b may be configured with an operating system, including without limitation any of those discussed above, as well as any commercially (or freely) available server operating systems. Each of the servers 215-b may also be running one or more applications, which can be configured to provide services to one or more clients 205-b and/or other servers 215-b.

Merely by way of example, one of the servers 215-b may be a web server, which can be used, merely by way of example, to process requests for web pages or other electronic documents from user computers 205-b. The web server can also run a variety of server applications, including HTTP servers, FTP servers, CGI servers, database servers, Java servers, and the like. In some embodiments of the invention, the web server may be configured to serve web pages that can be operated within a web browser on one or more of the user computers 205-b to perform methods of the invention.

The server computers 215-b, in some embodiments, might include one or more application servers, which can be configured with one or more applications accessible by a client running on one or more of the client computers 205-b and/or other servers 215-b. Merely by way of example, the server(s) 215-b can be one or more general purpose computers capable of executing programs or scripts in response to the user computers 205-b and/or other servers 215-b, including without limitation web applications (which might, in some cases, be configured to perform methods provided by various embodiments). Merely by way of example, a web application can be implemented as one or more scripts or programs written in any suitable programming language, such as JAVA, C, C#™ or C++, and/or any scripting language, such as Perl, Python, or TCL, as well as combinations of any programming and/or scripting languages. The application server(s) can also include database servers, including without limitation those commercially available from Oracle, Microsoft, SYBASE, IBM and the like, which can process requests from clients (including, depending on the configuration, dedicated database clients, API clients, web browsers, etc.) running on a user computer 205-b and/or another server 215-b. In some embodiments, an application server can create web pages dynamically for displaying the information in accordance with various embodiments, such as web pages for a user to review transaction information to suspend the transaction, permit the transaction, or forward the transaction record for further review. Data provided by an application server may be formatted as one or more web pages (comprising HTML, JAVASCRIPT, etc., for example) and/or may be forwarded to a user computer 205-b via a web server (as described above, for example). Similarly, a web server might receive web page requests and/or input data from a user computer 205-b and/or forward the web page requests and/or input data to an application server. In some cases a web server may be integrated with an application server.

In accordance with further embodiments, one or more servers 215-b can function as a file server and/or can include one or more of the files (e.g., application code, data files, etc.) necessary to implement various disclosed methods, incorporated by an application running on a user computer 205-b and/or another server 215-b. Alternatively, as those skilled in the art will appreciate, a file server can include all necessary files, allowing such an application to be invoked remotely by a user computer 205-b and/or server 215-b.

It should be noted that the functions described with respect to various servers herein (e.g., application server, database server, web server, file server, etc.) can be performed by a single server and/or a plurality of specialized servers, depending on implementation-specific needs and parameters.

In certain embodiments, the system can include one or more databases 220-b. The location of the database(s) 220-b is discretionary: merely by way of example, a database 220a-b might reside on a storage medium local to (and/or resident in) a server 215a-b (and/or a user computer 205-b). Alternatively, a database 220b-b can be remote from any or all of the computers 205-b, 215-b, so long as it can be in communication (e.g., via the network 210-b) with one or more of these. In a particular set of embodiments, a database 220-b can reside in a storage-area network (“SAN”) familiar to those skilled in the art. (Likewise, any necessary files for performing the functions attributed to the computers 205-b, 215-b can be stored locally on the respective computer and/or remotely, as appropriate.) In one set of embodiments, the database 235-b can be a relational database, such as an Oracle database, that is adapted to store, update, and retrieve data in response to SQL-formatted commands. The database might be controlled and/or maintained by a database server, as described above, for example.

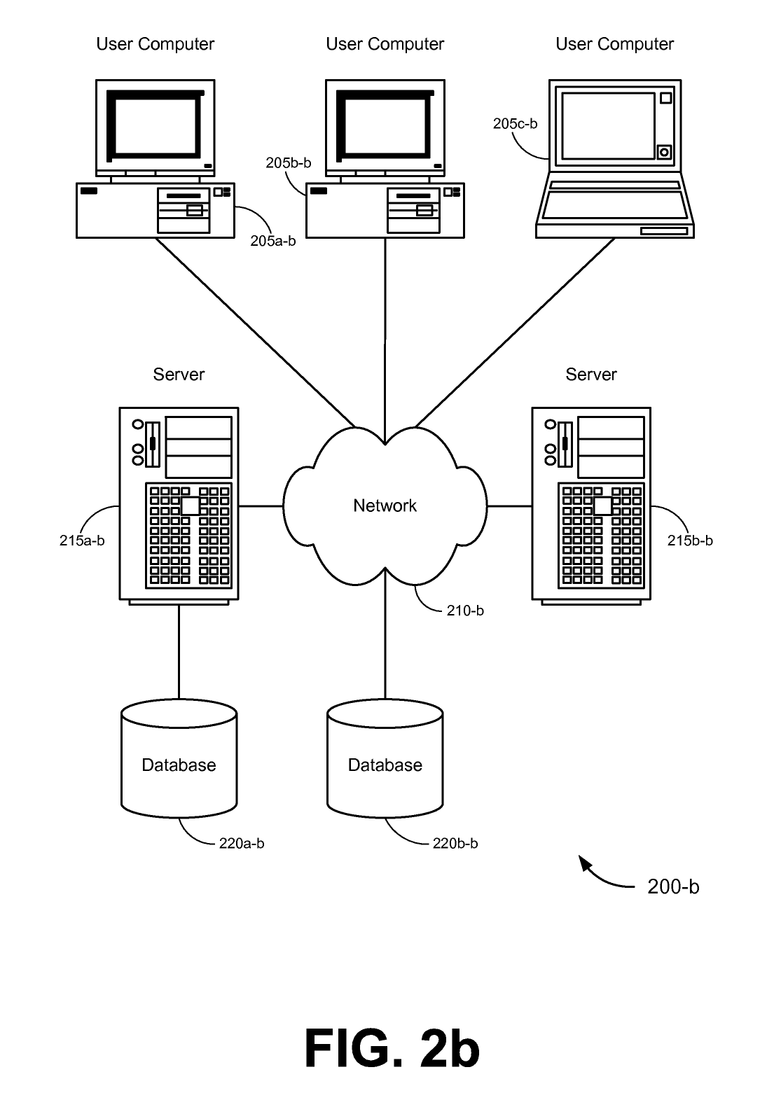

FIG. 3 illustrates a simplified embodiment of a list 300 of persons banned from financial transactions for a particular country. Such a list may be in the form of the table and/or database. In the embodiment illustrated, there are three columns: a name column 310, a citizenship column 320, and an organizations column 330. As those with skill in the art will recognize, the list/table may have any number of columns (or fields) containing information on persons restricted from conducting financial transactions in various countries. Further, different countries may include different categories of information on the persons restricted from conducting financial transactions. Further, simply because a category or column of information is present, this may not mean the corresponding data is present for each person in the table/list. Information from such a list 300 may be used to populate a master list of banned persons such as Master list of banned persons 180 in FIG. 1. Further, although information may be derived from list 300 to populate master list of banned persons 180, additional information may be added by a person such as user 190-1 illustrated in FIG. 1. For example, one piece of information that may be added is that each person appearing on a country's list of persons banned from performing financial transactions is always linked to the country whose list the person appears on.

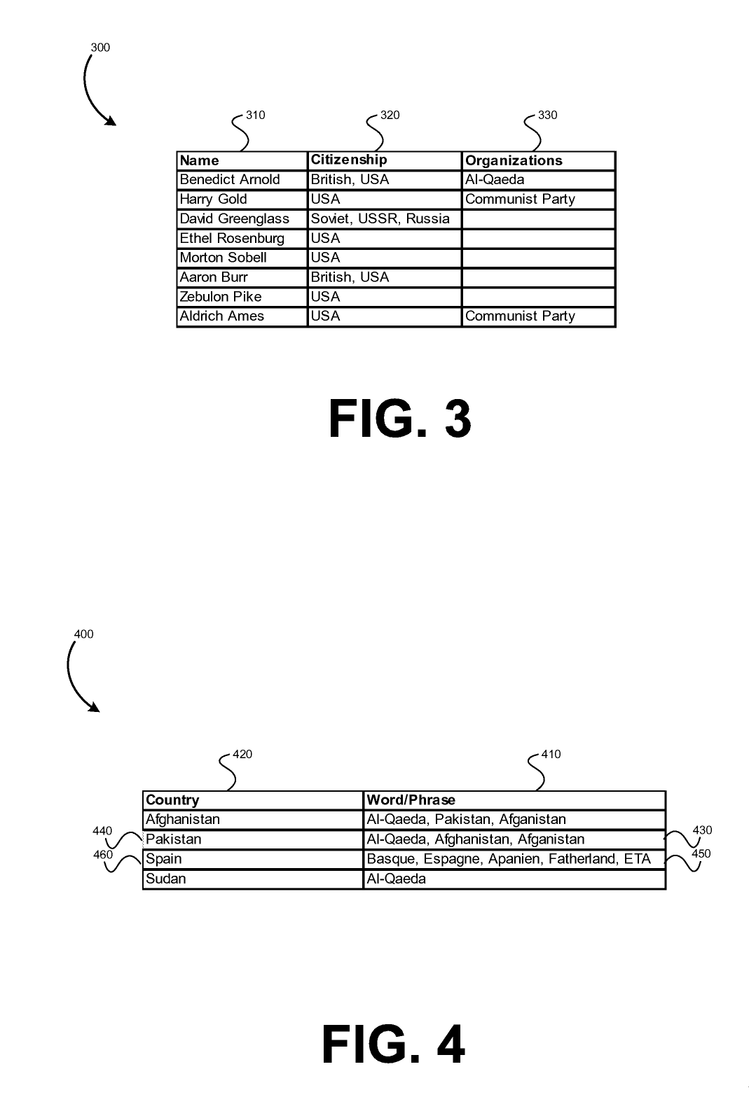

FIG. 4 illustrates a simplified embodiment of a table 400 from a GeoDictionary database. The embodiment of FIG. 4 illustrates a table with two columns: word/phrase column 410 and a country column 420. As can be seen, a country appearing in country column 420 is associated with one or more words and/or phrases appearing in word/phrase column 410. Any word and/or phrase may appear in word/phrase column 410. Therefore, word/phrase column 410 may contain locations, countries, organizations, ethnicities, religions, sects of religions, political parties, alternate spellings of words, common misspellings of words, etc. Country column 420 may a country (or multiple countries) associated with the word/phrase appearing in word/phrase column 410. As those with skill in the art will recognize, as opposed to being organized by countries, other GeoDictionaries may be organized by region, continent, state, city, etc. As an example of how countries may be related, Afghanistan appears in entry 430 in word/phrase column 410. Here, Afghanistan is associated with the country Pakistan, appearing as entry 440. This may be because there is a porous border allowing easy transit for persons between Pakistan and Afghanistan.

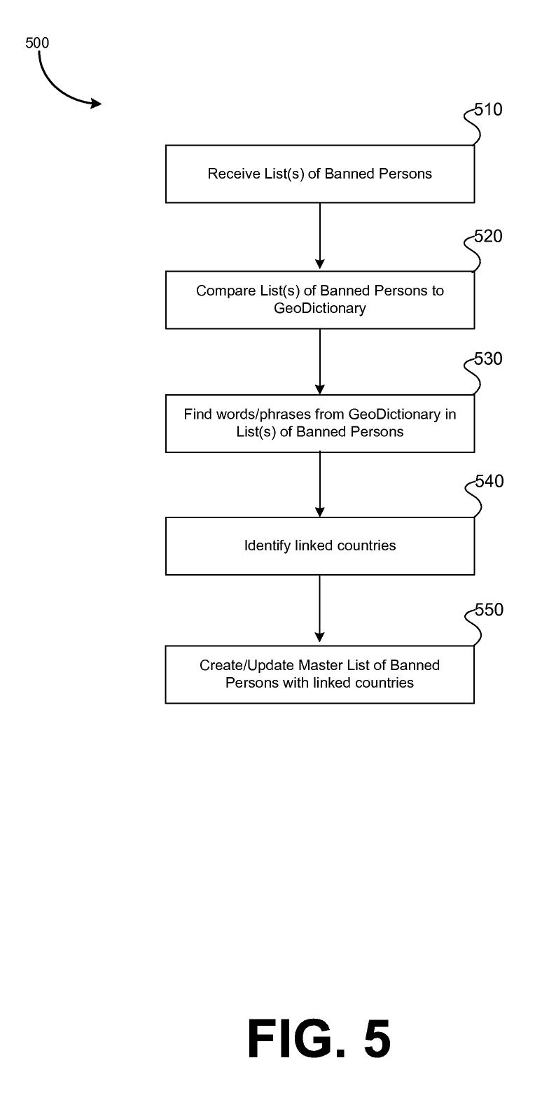

The system 100 of FIG. 1, in conjunction with the host computer system of FIG. 2A, the lists of banned persons, such as that illustrated in FIG. 3, and a GeoDictionary, such as that illustrated in FIG. 4, may be used to link words and/or phrases in a list of persons banned from financial transactions with associated countries. FIG. 5 illustrates a simplified method 500 of linking words and/or phrases in a list of persons banned from financial transactions with associated countries. At block 510, one or more lists of banned persons may be received. Such lists may be received at a host computer system, or some other computer system. These lists of banned persons may be automatically received after a predetermined period of time, or a user may acquire a new list when updates have been made available.

These lists of banned persons may be compared to a database, such as a GeoDictionary database at block 520. Such a comparison may involve various search techniques, such as a binary search tree. At block 530, common words and/or phrases appearing in both the GeoDictionary and the lists of banned persons may be found and identified. For example, the list(s) of banned persons may be searched for words/phrases appearing in the GeoDictionary. At block 540, the one or more countries (or other locations) linked to the common words and/or phrases in the GeoDictionary may be identified. At block 550, a master list of banned persons, containing information relating to the identified countries, may be created or updated. In some embodiments, the lists of banned persons in the master list of banned persons are the same lists.

As an example of the previous method consider the following scenario, provided for illustration purposes only. An entity hosting financial transactions receives a list of banned persons. One of the persons listed on this list is Osama bin Laden. The list of banned persons also notes that Osama bin Laden is a member of Al Qaeda and is a citizen of Saudi Arabia. This list of banned persons is compared to a GeoDictionary database. In the GeoDictionary, the phrase Al Qaeda is linked with the country of Afghanistan. The phrase Al Qaeda is then identified as being in common to both the list of banned persons and the GeoDictionary. Consequently, the name Osama Bin Laden is linked to Afghanistan. The master list of banned persons is then created or updated to note that Osama bin Laden is linked to the countries of Afghanistan in addition to being linked to Saudi Arabia.

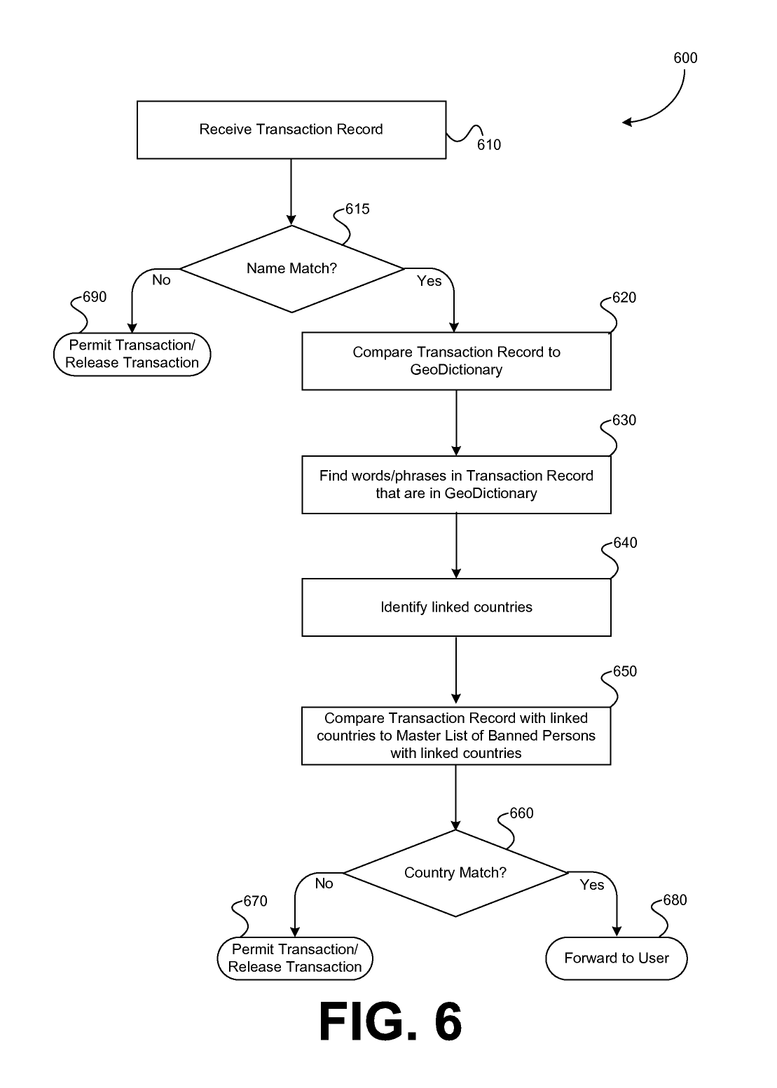

FIG. 6 illustrates a simplified method of determining whether a person involved in a financial transaction warrants further investigation as to whether she is a person banned from financial transactions. Such a method may be used in conjunction with the devices and systems discussed in relation to FIGS. 1 through 4, and methods discussed in relation to FIG. 5. Or, the method of FIG. 6 may be employed with other systems and/or devices. At block 610, a transaction record may be received, such as at the host computer system 170 of FIG. 1. Such a transaction record may include information such as the sender's name, the sender's address, the sender's passport number, the sender's license number, the recipient's name, the recipient's address, the recipient's passport number, the recipient's drivers license number, the recipient's date of birth, the amount of the transaction, the source of the funds for the transaction (such as a bank account number), etc. and again, as previously discussed, the amount of information gathered regarding the transaction, and contained in the transaction record, may vary depending on factors such as the country the transaction originates from, the destination country of the transaction, and the amount of the transaction.

At block 612, the financial transaction may be suspended until it is determined that the sender and/or recipient is not banned from conducting financial transactions. Such a suspension may mean that if a recipient attempts to retrieve or complete the financial transaction prior to the suspended status being removed, the recipient will be denied.

At block 615, it may be evaluated whether any name appearing in the transaction record matches the name appearing on a list of persons banned from conducting financial transactions (or a master list of persons banned from conducting financial transactions). Such a comparison may involve various search techniques, such as a binary search tree. If there is no match, at block 690 the transaction may be released from the suspended status and be permitted to be completed. This may include the recipient being allowed to receive the funds and/or gain access to the funds sent by the sender. If no name match occurs, a user may never be presented with the transaction for review. As those with skill in the art will recognize, additional information regarding the name appearing in the transaction record and the name appearing on the list of persons banned from conducting financial transactions may be required to reduce the instances of false positives. For example, a match of birthdate may also be required.

However, at block 615, if the name appearing in the transaction record does match a name appearing on a list of banned persons and/or master list of banned persons additional steps may be taken. At block 620 the transaction record may then be compared to a GeoDictionary database. At block 630, words and/or phrases that are common to both the GeoDictionary and a transaction record may be found. At block 640, the countries that are linked to such common words and/or phrases in the GeoDictionary may be identified. These countries may be linked to the transaction record. Additionally, transaction records may already be linked with particular countries based on the country the transaction originated in, the country the recipient is located in, the country the headquarters of the entity hosting the financial transaction is located in, countries the sender identified as being relevant to the transaction (such as the sender's stating he or she was born in a foreign country), etc.

At block 650, the transaction record (along with the countries now linked to the transaction record) may be compared with one or more lists of banned persons from conducting financial transactions (possibly also including countries linked to the persons appearing on the list or lists). Therefore, all of the countries contained in a transaction record plus those countries linked to the transaction record using the GeoDictionary are compared to the countries contained in the record and linked to the record using the GeoDictionary of the person appearing on the list of persons banned from conducting financial transactions that the name appearing in the financial transaction matched at block 615. At block 660, it is determined if a country appearing in the transaction record or linked with the transaction record matches the country appearing with the name identified at block 615 or linked with the name identified at block 615. If there is no country match, at block 670 the transaction may be released from the suspended status and be permitted to be completed and/or allow the funds associated with the financial transaction to be delivered to the recipient.

However, if there is a country match at block 660, the transaction record may be forwarded to a user for review at block 680. This may involve displaying the transaction record along with the matching country data to the user. The user may then be able to release the transaction from the suspended status if he or she determines that the match is still a coincidence. The user may also be able to determine that there is a likelihood the name match and country match are not coincidences and further investigation is required. The user may then conduct further investigation, or may forward all pertinent information to an appropriate law enforcement agency.

By way of illustration, consider the following example incorporating the previous example involving Al Qaeda and Osama bin Laden. In a lapse of judgment, Osama bin Laden attempts to transfer funds from Pakistan to a supporter in Sudan. To do this, he goes to an agent location of an entity that conducts money transfers. He then completes a form identifying himself, his nationality, and the funds that he wishes to transfer. Upon submission of this information to complete the transaction, the information contained in the transaction record is compared to names and information contained in a list of persons banned from conducting financial transactions. This list may be a master list of persons banned from conducting financial transactions compiled from other lists produced by nations such as the United States and Afghanistan.

In this instance, the comparison matches the name Osama bin Laden from the transaction record to the name Osama bin Laden appearing on a master list of persons banned from conducting financial transactions maintained by the entity hosting the financial transaction. If the transaction is not in a suspended status already, the transaction may be suspended until a determination is made as to whether the Osama bin Laden conducting the transaction is the same Osama bin Laden appearing on the master list of persons banned from conducting financial transactions.

Information supplied by Osama bin Laden at the agent location may be compared to words and/or phrases present in the GeoDictionary. In addition to the countries already identified in the transaction (Pakistan and Sudan), key words and/or phrases present in both the transaction record and GeoDictionary may result in additional countries being linked to the transaction record. For example, the presence of the country of Pakistan in the transaction record may result in the country of Afghanistan also being associated with the transaction record (perhaps due to the existence of a poor border controls between the countries). Therefore, at this point, Afghanistan, Pakistan, and Sudan are linked to the transaction record.

These countries may then be compared with countries that are linked with the Osama bin Laden appearing on the list of persons prohibited from conducting financial transactions. Referring back to the earlier example involving Osama bin Laden, the Osama bin Laden appearing on the master list of persons banned from conducting financial transactions (following a comparison to the GeoDictionary) is linked with Saudi Arabia and Afghanistan. Therefore, both the Osama bin Laden appearing on the master list of persons banned from conducting financial transactions and the Osama bin Laden who attempted to conduct the money transfer transaction are both linked to Afghanistan. If a GeoDictionary had not been employed, the common link to Afghanistan may have been unnoticed. Therefore, because there is a country match (Afghanistan), the transaction record may remain in a suspended status and be forwarded to a user to be reviewed and/or forwarded along to the appropriate government agency (perhaps of Afghanistan, Pakistan, Sudan, and/or the United States).

To illustrate another aspect of the invention, consider the following example involving the methods of FIGS. 5 and 6. A man named Bill Hogan wishes to transfer money to a relative in Canada. To do this, Bill Hogan telephones a call center to conduct the money transfer transaction. An employee of the entity hosting the money transfer collects information on Bill Hogan. This information includes his name and address, the recipient's name and address, and the amount of the transaction. The names present in this transaction record are compared to names appearing on lists of persons prohibited from conducting financial transactions. Unfortunately, by coincidence only, a different person named Bill Hogan is on a list of persons prohibited from conducting financial transactions. The Bill Hogan prohibited from conducting financial transactions is a known member of the IRA. When this Bill Hogan's information found in the list of persons banned from conducting financial transactions is compared to the GeoDictionary, the countries/regions of Ireland, Great Britain, Northern Ireland, and Wales are linked to the banned Bill Hogan. The transaction record of the other Bill Hogan is compared to the words and/or phrases appearing in the GeoDictionary. Following the comparison, only the country of the United States is linked to the transaction record of the Bill Hogan attempting to send money to Canada.

Therefore, the Bill Hogan prohibited from conducting financial transactions is linked to the countries and regions of Ireland, Great Britain, Northern Ireland, and Wales. While the Bill Hogan attempting to transfer funds to Canada is linked to the United States and Canada, a comparison between the countries linked to each Bill Hogan yields no common countries. Due to this it may be determined that the name Bill Hogan is a mere coincidence, and they are not the same person.

Without the use of a geo-dictionary, it may have required investigation by the user to determine that there were two different Bill Hogans. However, by employing a geo-dictionary, it was possible to determine without user intervention that the Bill Hogan conducting the financial transaction was most likely not the Bill Hogan listed on the list of persons banned from conducting financial transactions. Therefore, because an investigation by the user was unnecessary, the transaction may be completed quicker and/or the entity hosting the financial transaction may have saved money by not being required to devote resources to determining whether the Bill Hogans were in fact the same or different persons.

It should be noted that the methods, systems, and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various steps may be added, omitted, or combined. Also, features described with respect to certain embodiments may be combined in various other embodiments. Different aspects and elements of the embodiments may be combined in a similar manner. Also, it should be emphasized that technology evolves and, thus, many of the elements are examples and should not be interpreted to limit the scope of the invention.

Specific details are given in the description to provide a thorough understanding of the embodiments. However, it will be understood by one of ordinary skill in the art that the embodiments may be practiced without these specific details. For example, well-known circuits, processes, algorithms, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the spirit and scope of the invention.

Also, it is noted that the embodiments may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure. Furthermore, embodiments of the methods may be implemented by hardware, software, firmware, middleware, microcode, hardware description languages, or any combination thereof. When implemented in software, firmware, middleware, or microcode, the program code or code segments to perform the necessary tasks may be stored in a computer-readable medium such as a storage medium. Processors may perform the necessary tasks.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

What is claimed is:

1. A method for determining compliance with a listing of persons banned from conducting financial transactions, the method comprising:
providing a host computer system, wherein the host computer system is comprised of a processor and a computer-readable storage device;
receiving, at the host computer system, the listing of persons banned from conducting financial transactions, wherein the listing of persons identifies at least a first person linked with a first location;
receiving, at the host computer system, a plurality of words and/or phrases and a plurality of locations, wherein each location of the plurality of locations is linked to at least one word and/or phrase of the plurality of words and/or phrases, thereby creating a geographic-word database;
receiving, at the host computer system, financial transaction information, wherein the financial transaction information comprises information about a sender and/or recipient of a financial transaction;
comparing, at the host computer system, words and/or phrases present in the financial transaction information with the plurality of words and/or phrases in the geographic-word database;
identifying, at the host computer system, a first common word and/or phrase in the financial transaction information and the geographic-word database;
linking, at the host computer system, a second location in the geographic-word database previously linked with the first common word and/or phrase, to the financial transaction information; and
comparing, at the host computer system, the second location with the first location.

2. The method of claim 1, further comprising:
comparing, at the computer system, a name of the sender contained in the financial transaction information with a name of the first person identified in the listing of persons banned from financial transactions; and
determining, at the computer system, the name of the sender contained in the financial transaction information matches the name of the first person identified in the listing of persons banned from financial transactions.

3. The method of claim 2, further comprising:
comparing, at the host computer system, words and/or phrases present in the listing of persons banned from conducting financial transactions with the plurality of words and/or phrases present in the geographic-word database;
identifying, at the host computer system, a second common word and/or phrase in a listing of the first person in the list of persons banned from conduction financial transactions and the geographic-word database; and
linking, at the host computer system, the first location in the geographic-word database previously linked with the second common word and/or phrase to the listing of the first person in the listing of persons banned from conducting financial transactions.

4. The method of claim 3, further comprising:
determining, at the host computer system, the second location linked with the financial transaction information does not match the first location linked to the first person in the listing of persons banned from conducting financing transactions.

5. The method of claim 4, further comprising:
suspending, at the host computer system, a financial transaction linked to the financial transaction information pending an outcome of determining compliance with the listing of persons banned from conducting financial transactions.

6. The method of claim 5, further comprising:
releasing, at the host computer system, the financial transaction from suspension following a determination of compliance with the listing of persons banned from conducting financial transactions.

7. The method of claim 3, further comprising:
determining, at the host computer system, the second location linked to the financial transaction information matches the first location linked to the first person appearing in the listing of persons banned from conducting financial transactions; and
forwarding, by the host computer system, the financial transaction information to a user for review.

8. The method of claim 1, wherein the first location is a first country and the second location is a second country.

9. The method of claim 8, further comprising:
linking, at the host computer system, the first country to the second country, such that linking to the first country also serves as a link to the second country.

10. The method of claim 1, wherein the listing of persons banned from conducting financial transactions is compiled from a plurality of lists produced by various countries of persons banned from conducting financial transactions.

11. The method of claim 1, wherein the financial transaction is a money transfer transaction and the financial transaction information is money transfer information.

12. A system for determining compliance with a list of persons prohibited from conducting financial transactions, the system comprising:
a user display, wherein the user display is configured to display financial transaction information to a user;
an input device, wherein the input device is configured to receive input from the user to change a status of a financial transaction;
a computer-readable storage medium;
a database, wherein the database resides on the computer-readable storage medium and comprises a plurality of defined words and/or phrases with each of the plurality of defined words and/or phrases linked to one or more names of countries;
a host computer system, comprising a processor and the computer-readable storage medium, the computer-readable storage medium having encoded thereon a set of instructions to control operation of the host computer system, the set of instructions comprising:
instructions for receiving a listing of banned persons, wherein the listing of banned persons comprises names of banned persons and additional information for at least a subset of the banned persons;
instructions for comparing words and/or phrases appearing in a listing of a banned person on the list of banned persons with the plurality of defined words and/or phrases appearing in the database;
instructions for identifying common words and/or phrases appearing in both the listing of the banned person and the database, thereby identifying a first set of common defined words and/or phrases; and
instructions for linking the listing of the banned person to one or more names of countries linked with the first set of common defined words and/or phrases in the database.

13. The system of claim 12, wherein the instructions further comprise:
instructions for receiving a financial transaction record, wherein the financial transaction record comprises a person's name and information about a sender and/or recipient of a financial transaction;
instructions for comparing the person's name appearing in the financial transaction record with names of persons appearing in the listing of banned persons; and
instructions for identifying the person's name appearing in the financial transaction record as also appearing in the listing of banned persons.

14. The system of claim 13, wherein the instructions further comprise:
instructions for comparing words and/or phrases appearing in the financial transaction record with the plurality of defined words and/or phrases appearing in the database;
instructions for identifying common words and/or phrases appearing in both the financial transaction record and the database, thereby identifying a second set of common defined words and/or phrases; and
instructions for linking the financial transaction record to one or more names of countries linked with the second set of common defined words and/or phrases in the database.

15. The system of claim 14, wherein the instructions further comprise:
instructions for comparing the countries linked to the financial transaction record and the countries linked with the name in the listing of prohibited persons.

16. The system of claim 15, wherein the instructions further comprise:
instructions for identifying a common country linked to the financial transaction record and to the name in the listing of banned persons; and
instructions for forwarding the financial transaction record to the user display for review by the user.

17. The system of claim 15, wherein the instructions further comprise:
instructions for determining no common country exists between the countries linked to the financial transaction record and the countries linked to the name in the listing of banned persons.

18. The system of claim 17, wherein the instructions further comprise:
instructions for placing a financial transaction associated with the financial transaction record in a suspended status pending the determination of compliance with the list of persons banned from conducting financial transactions; and
instructions for releasing the financial transaction associated with the financial transaction record from the suspended status following the determination that no common country exists between the countries linked to the financial transaction record and the countries linked to the name in the listing of banned persons.

19. The system of claim 18, wherein the financial transaction is a money transfer transaction.

20. A computer-readable storage medium having a computer-readable program embodied therein for directing operation of a computer system, including a processor and a storage device, wherein the computer-readable program includes instructions for operating the computer system to determining compliance with a list of persons prohibited from conducting financial transactions, the method comprising:
receiving, at the computer system, a money transfer transaction record, wherein the money transfer transaction record comprises information regarding a sender of a money transfer;
comparing, at the computer system, a name of the sender to a list of names of persons prohibited from conducting financial transactions;
determining, at the computer system, a name of the sender matches a name on the list of names of persons prohibited from conducting financial transactions;
suspending, at the computer system, a money transfer transaction, associated with the money transfer transaction record, by placing the money transfer transaction in a suspended status;
searching, at the computer system, the money transfer transaction record for a set of keywords and/or key phrases;
locating, at the computer system, at least one keyword and/or key phrase within the money transfer transaction record;
linking, at the computer system, the money transfer transaction record with a country name linked with the at least one keyword and/or key phrase;
searching, at the computer system, countries linked with the name on the list of names of persons prohibited from conducting financial transactions for countries linked to the money transfer transaction record;
determining, at the computer system, no country linked with the name on the list of names of persons prohibited from conducting financial transactions matches any country name linked to the money transfer transaction record; and
releasing, at the computer system, the money transfer transaction from the suspended status.
